(19) United States
(12) Patent Application Publication
(10) Pub. No.: US 2002/0007344 A1
(43) Pub. Date: Jan. 17, 2002

(54) Settlement apparatus, method, and program

(75) Inventor: Jun Kikuchi, Shizuoka-ken (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 09/902,018

(22) Filed: Jul. 10, 2001

(30) Foreign Application Priority Data
Jul. 13, 2000 (JP) 2000-213109

(51) Int. Cl. G06F 17/60

(52) U.S. Cl. 705/39; 705/44

(57) ABSTRACT

A settlement server comprises an authorization unit which performs an authorization transaction of collecting an amount of payment for an article sold at a specified site on a network in place of a seller who sells the article. Particularly, the server further comprises a settlement processing unit which performs data processing of pooling at least a part of the payment amount collected in the authorization transaction as a deposit, and appropriating the deposit as payment for other articles to be bought by the seller at the specified site.

### CROSS-REFERENCE TO RELATED APPLICATIONS

This application is based upon and claims the benefit of priority from the prior Japanese Patent Application No. 2000-213109, filed Jul. 13, 2000, the entire contents of which are incorporated herein by reference.

### BACKGROUND OF THE INVENTION

1. Field of the Invention

The present invention relates to an electronic trade system for personal electronic trade carried out via a specified site on Internet, for example, and more particularly to a settlement apparatus, method, and program used for settling a financial transaction such as a credit card transaction in the electronic trade system.

2. Description of the Related Art

In recent years, the number of users of shopping sites on the Internet has increased. An article bought at a site is paid for by methods such as bank transfer, cash on delivery, or a credit card. A credit card can generally only be used at a shopping site which has a credit authorization terminal to online-process a credit card transaction and authorize the transaction.

For example, various articles are displayed by a plurality of individuals at the shopping site in the form of an auction or a flea market, and bought by other individuals. That is, the user of the shopping site temporarily becomes a seller only when a user's article is displayed. Therefore, it is difficult for the seller to prepare the credit authorization terminal.

Under these circumstances, for example, a site manager sometimes serves as a settling agent so that the credit card can be utilized in personal electronic trade. The settling agent has the credit authorization terminal online-connected to the credit card company, and acts for the seller to conduct the credit card transaction between a buyer and the credit card company. More specifically, when the buyer proposes to pay for the article by credit card, the settling agent refers to the credit card company in place of the seller, and transfers the amount paid by the credit card company instead of the buyer into a bank account designated by the seller.

However, the settling agent has to pay a transaction fee to the credit card company and further pay a transfer fee to a bank for each credit card transaction. Such fees are ultimately redirected to the payment amount of the buyer in the same manner as the delivery charge for a delivered article. If the article is of a type available on the general market place, the price tag inevitably approaches the market price of one sold in a conventional store. This is a factor impairing the merits of electronic trade in which the article can be sold at a price lower than the market price.

Moreover, procedures such as credit card transactions and bank transfers are independent business operations to be executed in parallel with Internet site management. As a result, with the increase in the number of financial transactions, the processing burden loaded onto a server computer of the site manager excessively increases.

### BRIEF SUMMARY OF THE INVENTION

An object of the present invention is to provide a settlement apparatus, method, and program that can reduce the transaction costs involved in electronic trade.

According to a first aspect of the present invention, there is provided a settlement apparatus comprising: an authorization unit which performs an authorization transaction of collecting the amount of payment for an article bought by a buyer at a specified site on a network in place of a seller who sells the article; and a settlement unit which performs data processing of pooling at least a part of the payment amount collected in the authorization transaction as a deposit, and appropriating the deposit as payment for other articles to be bought by the seller at the specified site.

According to a second aspect of the present invention, there is provided a settlement method comprising: an authorization transaction of collecting the amount of payment for an article bought by a buyer at a specified site on a network in place of a seller who sells the article; and data processing of pooling at least a part of the payment amount collected in the authorization transaction as a deposit, and appropriating the deposit as payment for other articles to be bought by the seller at the specified site.

According to a third aspect of the present invention, there is provided a machine-readable computer settlement program to perform an operation comprising: an authorization transaction of collecting the amount of payment for an article bought by a buyer at a specified site on a network in place of a seller who sells the article; and data processing of pooling at least a part of the payment amount collected in the authorization transaction as a deposit, and appropriating the deposit as payment for other articles to be bought by the seller at the specified site.

With the settling apparatus, method, and program, a part of the payment amount collected in the authorization transaction is pooled as the deposit, and appropriated as payment for other articles to be bought by the seller at the specified site. Thereby, in a case where the seller buys other articles within the amount of the deposit, a transaction fee to be paid to a financial institution such as a credit card company can be obviated. Moreover, in a case where the seller agrees to pool the whole payment amount as the deposit, a bank transfer fee for the payment amount can be obviated. Furthermore, the frequency of procedures such as credit card transactions and bank transfers can be reduced with respect to an increase in the transaction requests. Therefore, the processing burden for the procedures can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a diagram showing a total constitution of an electronic trade system according to one embodiment of the present invention;

FIG. 2 is a block diagram showing a constitution of a settlement server shown in FIG. 1 in detail;

FIG. 3 is a memory map showing a constitution of a seller account file shown in FIG. 2;

FIG. 4 is an explanatory view showing the contents of various electronic mail transmitted or received by the settlement server shown in FIG. 2; and

FIG. 5 is a flowchart showing an operation of a settlement processing unit shown in FIG. 2.

### DETAILED DESCRIPTION OF THE INVENTION

An electronic trade system according to one embodiment of the present invention will be described hereinafter with reference to the accompanying drawings. This electronic trade system is used for personal electronic trade carried out via a specified site on a network.

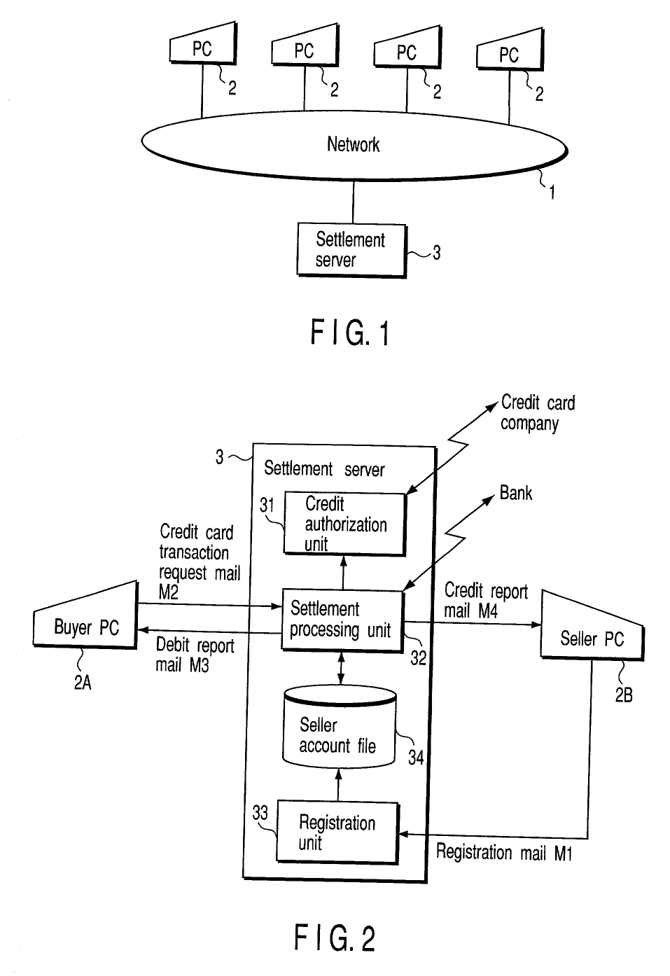

FIG. 1 shows a total constitution of the electronic trade system. In the electronic trade system, a plurality of personal computers (PC) 2 and a settlement server 3 are interconnected by means of a network 1 such as the Internet or the like. The settlement server 3 is a part of a server computer which is continuously connected to the network 1 in order to provide a shopping site such as an auction or a flea market. The server 3 is controlled by a site manager who serves as a settling agent for settling a financial transaction of the personal electronic trade carried out at the shopping site. Each of the plurality of computers 2 is a personal use client computer which is connected to the network 1 at least during use of the shopping site, and controlled by a plurality of users including individuals or a group who utilize the shopping site.

When the user of the shopping site becomes a seller who sells an article, the seller prepares article information such as a photo, description, and selling conditions for the article in the form of data files, and uploads the article information from the client computer to the server computer. Then, the server computer opens the article information to the public at the shopping site. Moreover, when the user of the shopping site becomes a buyer who buys a desired article, the buyer browses the shopping site and offers to buy the desired article after confirming the photo, description, and selling conditions opened as the article information of the desired article. In the offer, the buyer designates a transaction method such as a bank transfer, cash-on-delivery, or credit card. This offer is notified to the seller from the shopping site. A contract of electronic trade is established based on a mutual agreement between the buyer and the seller.

When bank transfer is designated as the transaction method for paying for the article, the seller sends the article to the buyer after confirming that the payment amount has been remitted to the seller's bank account. Moreover, when cash-on-delivery is designated, the seller requests the delivery company to deliver the article to the buyer and collect the amount paid in cash for the article on delivery, and receives the amount collected by the delivery company. Furthermore, when credit card is designated, the settling agent, that is, the site manager acts as the seller to conduct the credit card transaction between the buyer and the credit card company. For instance, the seller presents information such as a mail address of the settling agent to the buyer after the electronic trade contract is established, and the buyer requests the settling agent for credit card transaction via the network 1. The settling agent processes the request for credit card transaction from the buyer to collect the amount paid by the credit card company instead of the buyer and to remit the amount paid into a bank account of the seller, and notifies the seller of the transaction result. The seller confirms from the transaction result that the credit card transaction is authorized, and sends the article to the buyer. Here, the transaction fee for the credit card transaction is added as a buyer's charge to a demand payment, and the bank transfer fee is subtracted as a seller's charge from the payment amount.

The settlement server 3 automatically performs settlement for the aforementioned credit card transaction. The settlement server 3 is configured to transfer the amount paid by the credit card company into the bank account designated by the seller when the seller has been registered as a client for the settlement. In addition, the settlement server 3 is capable of pooling at least a part of the payment amount as a deposit and appropriating the deposit as payment for other articles to be bought by the registered seller at the shopping site.

FIG. 2 shows a constitution of the settlement server 3. The settlement server 3 includes a central processing unit (CPU) for controlling server operations, a ROM for storing a control program for the CPU, and a RAM and hard disk drive (HDD) for storing input and output data of the CPU. The CPU executes the control program to constitute a credit authorization unit 31, a settlement processing unit 32, and a registration unit 33. The credit authorization unit 31 is online connected to the credit card company and performs a credit card transaction of collecting an amount of payment for the article bought by the buyer at the specified site on the network 1 in place of a seller who sells the article. The settlement processing unit 32 is connected between a buyer PC 2A and a seller PC 2B and performs data processing of pooling at least a part of the payment amount collected in the credit card transaction as a deposit, and appropriating the deposit as payment for other articles to be bought by the seller at the specified site. The registration unit 33 registers the seller who sells the article at the shopping site as a client of the settling agent. At least one of the RAM and HDD includes a seller account file 34 holding a list of account information for a plurality of registered sellers.

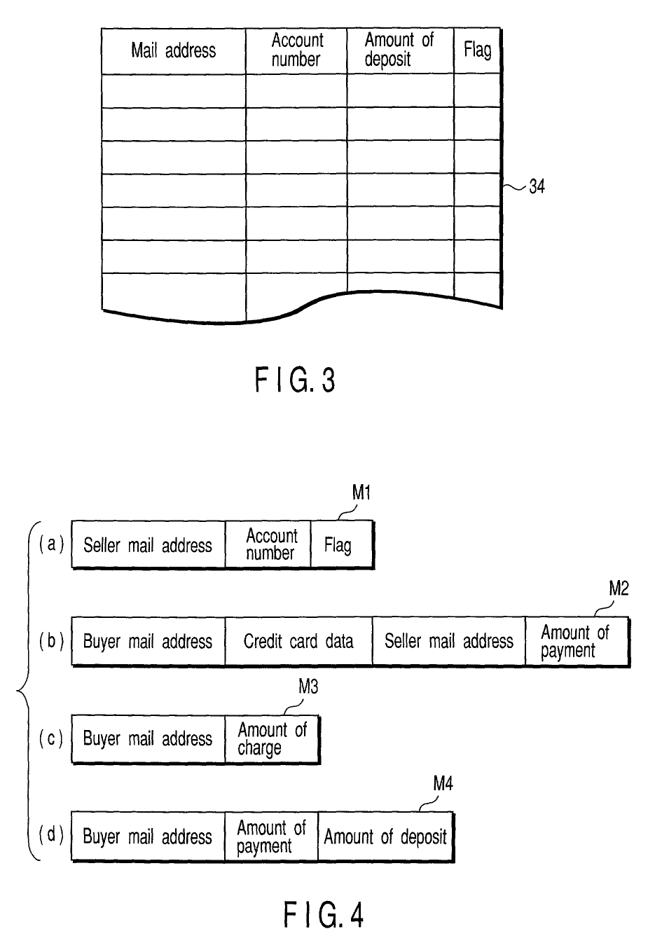

FIG. 3 shows a constitution of the seller account file 34. All account information of the seller account file 34 has the mail address of a registered seller, the account number of a financial institution (bank) designated by the registered seller identified by the mail address, the amount of deposit pooled for the registered seller, and pool selection flag F (F=1: to pool, F=0: not to pool) indicating whether or not the deposit is pooled for the registered seller.

The registration unit 33 is configured to process a registration mail Ml prepared by a seller who sells an article in the shopping site and sent from the seller PC 2B in the form of an electronic mail. The registration mail Ml is issued to request for registration of the seller as a client of the settling agent. As shown in FIG. 4A, the mail Ml includes information such as a seller mail address, account number of the bank account designated as a payment transfer destination by the seller, and pool selection flag F indicating whether or not the deposit is pooled. More specifically, upon receipt of the registration mail Ml via the network 1, the registration unit 33 checks whether the seller mail address obtained from the registration mail M1 is present in the seller account file 34. When the mail address is not present, the seller mail address, the account number and pool selection flag from the registration mail M1 are filed as account information in the seller account file 34. When the seller mail address is present, the account number and pool selection flag corresponding to the mail address are updated based on the content of the registration mail M1. The registration unit 33 registers the seller in this manner.

The settlement processing unit 32 is configured to process a credit card transaction request mail M2 prepared by a buyer who buys an article in the shopping site and sent from the buyer PC 2A in the form of the electronic mail. The request mail M2 is issued to request credit card transaction. As shown in FIG. 4B, the mail M2 includes payment information such as a buyer mail address, credit card data (i.e., a card number and validity term) of a buyer's credit card, mail address of the seller who sells the article to be bought, and amount of payment for the article to be bought.

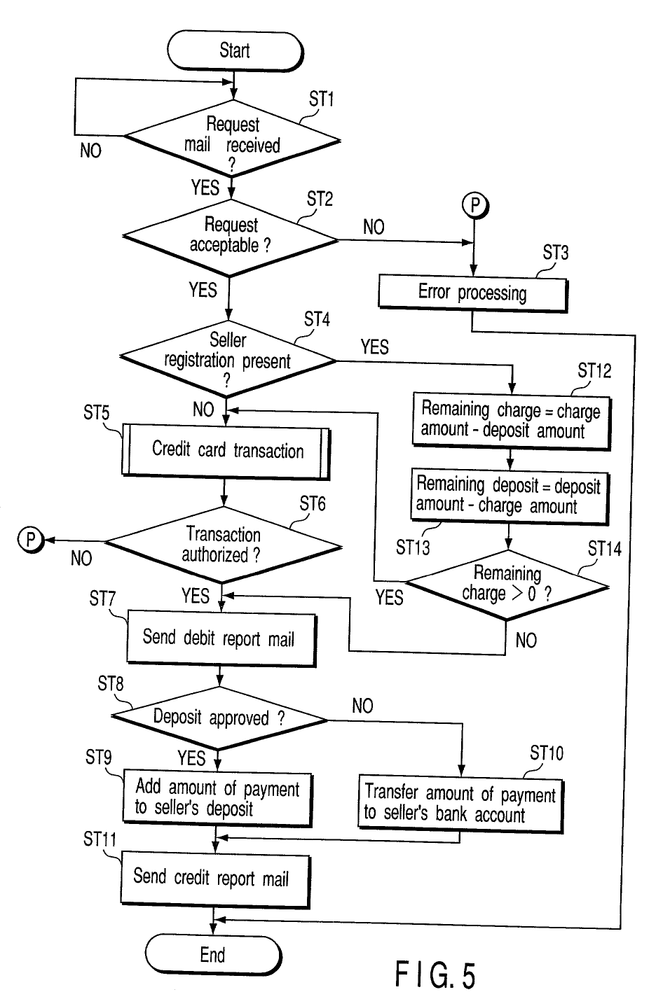

FIG. 5 shows an operation of the settlement processing unit 32. In the operation, it is repeatedly checked in step ST1 whether the request mail M2 is received via the network 1. Upon receipt of the request mail M2, the seller account file 34 is searched in step ST2 for the seller mail address obtained from the request mail M2 to determine whether the credit card transaction request is acceptable. When the seller mail address is not present, it is determined that the credit card transaction is made with respect to an unregistered seller, and not acceptable. Thus, an error processing is performed in step ST3. In this error processing, the buyer is informed that the credit card transaction is not acceptable, by means of an electronic mail delivered via the network 1. After step ST3, handling of the request mail M2 is completed.

When it is detected in step ST2 that the seller mail address is present in the seller account file 34, the seller account file 34 is searched in step ST4 for a mail address identical to the buyer mail address obtained from the credit card transaction request mail M2 to determine whether the buyer is registered as a seller who is a client of the settling agent. If the buyer does not turn to a seller who sells an article at the shopping site, it is confirmed that the mail address identical to the buyer mail address is not present. In this case, a credit card transaction is enabled in step ST5 on the basis of the payment information obtained from the credit card transaction request mail M2. In this transaction, the payment information is transferred to the credit authorization unit 31. At this time, the credit authorization unit 31 is online-connected to a credit card company and sends inquiries for credit card transaction on the credit card data and amount of payment included in the payment information. Here, the amount of payment is updated to include a transaction fee for the credit card transaction as a buyer's charge. The credit card company checks the validity of the credit card to determine whether the credit card transaction is approvable, and sends a result of determination back to the credit authorization unit 31. Upon receipt of the determination result, the settlement processing unit 31 recognizes that the credit card transaction has been completed, and checks in step ST6 whether the credit card transaction is authorized. When the credit card transaction is not authorized, step ST3 is executed after invalidating the process which has been made for the credit card transaction request mail M2.

When the credit card transaction is authorized, in step ST7, the settlement processing unit 32 prepares a debit report mail M3 reporting to the buyer that the credit card transaction has been authorized. As shown in (c) of FIG. 4, this report mail M3 includes the buyer mail address and the charge amount which has been settled by means of the credit card, and is sent in the form of an electronic mail to be delivered via the network 1 to the buyer PC 2A. Thereafter, in step ST8, the settlement processing unit 32 checks the pool selection flag stored in the seller account file 34 along with the seller mail address of the registered seller corresponding to the credit card transaction. When the pool selection flag is “1” which approves pooling of the payment amount collected for the registered seller as a deposit, the payment amount is subtracted by the transaction fee for the credit card transaction, and added in step ST9 to the amount of deposit stored in the seller account file 34 along with the seller mail address of the registered seller corresponding to the credit card transaction. In contrast, when the pool selection flag is “0” which does not approve pooling of the payment amount collected for the registered seller as a deposit, the payment amount is subtracted by the transaction fee for the credit card transaction and by a bank transfer fee in step ST10, and transferred to a bank account identified by the account number which is stored in the seller account file 34 along with the mail address of the registered seller corresponding to the credit card transaction.

After step ST9 or ST10, the settlement processing unit 32 prepares, in step S11, a credit report mail M4 reporting the seller that the payment amount has been collected. As shown in (d) of FIG. 4, the report mail M4 includes the buyer mail address, amount of payment, and amount of deposit, and is sent in the form of an electronic mail to be delivered via the network 1 to the seller PC 2B. Thereafter, handling of the request mail M2 is completed.

On the other hand, when a presence of the seller mail address identical to the buyer mail address obtained from the credit card transaction request mail M2 is detected in step ST4, it is confirmed that the buyer is a client of the settling agent when he or she turns to a seller who sells an article at the shopping site. Then, in step ST12, the settlement processing unit 32 retrieves the amount of deposit stored in the seller account file 34 along with the seller mail address identical to the buyer mail address, and subtracts the deposit amount from the amount of payment included in the request mail M2 to obtain the remaining charge. The remaining charge is set to “0” when the deposit amount exceeds the payment amount. Thereafter, in step ST13, the payment amount is subtracted from the deposit amount stored in the seller account file 34 along with the seller mail address identical to the buyer mail address to update the deposit amount. The deposit amount is updated to “0” when the payment amount exceeds the deposit amount. Thereafter, it is checked in step ST14 whether the remaining charge obtained in step ST12 is greater than “0”. When the remaining charge>“0”, the credit card transaction is performed in step ST5 on the basis of the payment amount replaced by the remaining charge. In contrast, step ST7 is executed without passing through steps ST5 and ST6.

In the electronic trade system of the embodiment described above, the settlement server 3 is possessed by the site manager who serves as a settling agent for settling a financial transaction of the personal electronic trade carried out at the shopping site by conducting the credit card transaction between the buyer and the credit card company in place of the registered seller. The registration unit 33 registers a seller who sells an article at the shopping site as a client of the settling agent. The settlement processing unit 32 is capable of pooling the payment amount to be remitted to the registered seller as a deposit, and appropriating the deposit as payment for other articles to be bought by the registered seller at the specified site. In a case where the registered seller agrees to pool the payment amount as the deposit, a bank transfer fee for the payment amount can be obviated. Further, in a case where the registered seller buys the other articles within the amount of deposit, a transaction fee to be paid to the credit card company for credit card transaction can be obviated. Moreover, even if the payment amount exceeds the deposit amount, the credit card transaction can be performed for payment of the remaining charge. With the structure described above, the frequency of procedures such as credit card transaction and bank =transfer can be reduced with respect to an increase of transaction requests. Therefore, a processing burden for the procedure can be reduced.

Moreover, the registration mail Ml from the seller is used for determining whether to pool the payment amount as a deposit. This structure is adaptable to a seller who wishes to save the payment amount from the required fee and a seller who wishes to immediately receive the payment amount so that it can be used for another purpose. Therefore, demands of different sellers can easily be satisfied.

Additionally, in the aforementioned embodiment, the whole payment amount is pooled as a deposit under approval of the seller. However, for example, 50% of the payment amount may be pooled and the remaining amount may be remitted to the seller. Further, a uniform pool rate may be determined by the settling agent, or different pool ratios may be determined within a range of 0% to 100% by registered sellers. In this case, it is preferable that each pool rate can be updated upon receipt of an electronic mail from a corresponding seller.

Moreover, the settlement of the credit card transaction has been described in the aforementioned embodiment, but the present invention can similarly be applied to settlement of the other transaction such as a bank money card transaction.

Furthermore, in the aforementioned embodiment, the settlement server 3 is possessed by the shopping site manager who serves as a settling agent for settling a credit card transaction of the personal electronic trade carried out at the shopping site. However, the settlement server 3 may be possessed by a credit card company, a financial institute, or another organization associated with the shopping site manager.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A settlement apparatus comprising:
an authorization unit which performs an authorization transaction of collecting an amount of payment for an article bought by a buyer at a specified site on a network in place of a seller who sells the article; and
a settlement processing unit which performs data processing of pooling at least a part of the payment amount collected in the authorization transaction as a deposit, and appropriating the deposit as payment for other articles to be bought by the seller at the specified site.

2. A settlement apparatus according to claim 1, wherein said settlement processing unit is configured to pool the payment amount as the deposit at a pool rate predetermined for the seller.

3. A settlement apparatus according to claim 1, wherein said settlement processing unit is configured to control said authorization unit such that the authorization transaction is performed for settling a charge remaining as a difference when the deposit amount is less than an amount of payment for the other articles to be bought by the seller.

4. A settlement apparatus according to claim 1, wherein said settlement processing unit is configured to report a result of the processing to the buyer and the seller.

5. A settlement apparatus according to claim 1, wherein said authorization unit is configured to perform the authorization transaction to a credit card company on the basis of payment information from the buyer of the article soled by the seller and report a result of the authorization transaction to said settlement processing unit.

6. A settlement apparatus according to claim 5, wherein said settlement processing unit is configured to pool the payment amount as the deposit at a pool rate predetermined for the seller, and perform a procedure of remitting a remainder of the payment amount to the seller.

7. A settlement apparatus according to claim 6, wherein said settlement processing unit is configured to update the payment amount such that a credit card transaction fee is included therein in the amount charged to the buyer.

8. A settlement apparatus according to claim 7, wherein said settlement processing unit is configured to subtract a bank transfer fee as a seller's charge from the payment amount authorized by the credit card company.

9. A settlement apparatus according to claim 8, further comprising a registration unit which registers the seller as a client thereof, on the basis of registration information from the seller.

10. A settlement apparatus according to claim 9, said settlement processing unit is configured to determine the pool rate of the payment amount on the basis of the registration information from the seller.

11. A settlement method comprising:
an authorization transaction of collecting an amount of payment for an article bought by a buyer at a specified site on a network in place of a seller who sells the article; and
data processing of pooling at least a part of the payment amount collected in the authorization transaction as a deposit, and appropriating the deposit as payment for other articles to be bought by the seller at the specified site.

12. A settlement method according to claim 11, wherein said data processing includes a process of pooling the payment amount as the deposit at a pool rate predetermined for the seller.

13. A settlement method according to claim 11, wherein said data processing includes a process of controlling the authorization transaction to be performed for settling a charge remaining as a difference when the deposit amount is less than an amount of payment for the other articles to be bought by the seller.

14. A settlement method according to claim 11, wherein said data processing includes a process of reporting a result of processing to the buyer and the seller.

15. A settlement method according to claim 11, wherein said authorization transaction is performed to a credit card company on the basis of payment information from the buyer of the article soled by the seller, and a result of the authorization transaction is reported for said data processing.

16. A settlement method according to claim 15, wherein said data processing includes a process of pooling the payment amount as the deposit at a pool rate predetermined for the seller, and performing a procedure of remitting a remainder of the payment amount to the seller.

17. A settlement method according to claim 16, wherein said data processing includes a process of updating the payment amount such that a credit card transaction fee is included therein in the amount charged to the buyer.

18. A settlement method according to claim 17, wherein said data processing includes a process of subtracting a bank transfer fee as a seller's charge from the payment amount authorized by the credit card company.

19. A settlement method according to claim 18, further comprising a registration process of registering the seller as a client thereof, on the basis of registration information from the seller.

20. A settlement method according to claim 19, said data processing includes a process of determining the pool rate of the payment amount on the basis of the registration information from the seller.

21. A machine-readable computer settlement program to perform an operation which comprises:
an authorization transaction of collecting an amount of payment for an article bought by a buyer at a specified site on a network in place of a seller who sells the article; and
data processing of pooling at least a part of the payment amount collected in the authorization transaction as a deposit, and appropriating the deposit as payment for other articles to be bought by the seller at the specified site.

22. A settlement program according to claim 21, wherein said data processing includes a process of pooling the payment amount as the deposit at a pool rate predetermined for the seller.

23. A settlement program according to claim 21, wherein said data processing includes a process of controlling the authorization transaction to be performed for settling a charge remaining as a difference when the deposit amount is less than an amount of payment for the other articles to be bought by the seller.

24. A settlement program according to claim 21, wherein said data processing includes a process of reporting a result of processing to the buyer and the seller.

25. A settlement program according to claim 21, wherein said authorization transaction is performed to a credit card company on the basis of payment information from the buyer of the article soled by the seller, and a result of the authorization transaction is reported for said data processing.

26. A settlement program according to claim 25, wherein said data processing includes a process of pooling the payment amount as the deposit at a pool rate predetermined for the seller, and performing a procedure of remitting a remainder of the payment amount to the seller.

27. A settlement program according to claim 26, wherein said data processing includes a process of updating the payment amount such that a credit card transaction fee is included therein in the amount charged to the buyer.

28. A settlement program according to claim 27, wherein said data processing includes a process of subtracting a bank transfer fee as a seller's charge from the payment amount authorized by the credit card company.

29. A settlement program according to claim 28, further comprising a registration process of registering the seller as a client thereof, on the basis of registration information from the seller.

30. A settlement program according to claim 29, said data processing includes a process of determining the pool rate of the payment amount on the basis of the registration information from the seller.
